(19) United States
(12) Patent Application Publication
(10) Pub. No.: US 2005/0058503 A1
(43) Pub. Date: Mar. 17, 2005

(54) Coupling device for connecting a fan blade to a rotatable part of a ceiling fan

(75) Inventor: Wu-Long Li, Taichung Hsien (TW)

Correspondence Address: FOLEY AND LARDNER;SUITE 500, 3000 K STREET NW, WASHINGTON, DC, 20007, US

(73) Assignee: Lain-Tsair SHYR

(21) Appl. No.: 10/659,366

(22) Filed: Sep. 11, 2003

(51) Int. Cl. F16D 1/00

(52) U.S. Cl. 403/349

(57) ABSTRACT

An insert-holding seat is formed on a first part of a coupling device, defines a receiving hole, and is formed with an engaging groove. A limiting member is disposed rotatably and rearwardly of the seat, and has a tongue-arresting groove. An insert is formed on a second part of the coupling device, and has an engaging tongue that is disposed rearwardly of the seat when the insert is inserted into and through the receiving hole in the seat. The limiting member is rotatable relative to the seat from a first angular position, where the tongue-arresting groove in the limiting member is angularly offset from the engaging groove in the seat, and to a second angular position, where the tongue-arresting groove is registered with the engaging groove in the seat.

### BACKGROUND OF THE INVENTION

1. Field of the Invention

This invention relates to a coupling device, more particularly to a coupling device for connecting a fan blade to a rotatable part of a ceiling fan.

2. Description of the Related Art

Referring to FIGS. 1 and 2, a conventional coupling device 1 is shown to include a first part 11 that is adapted to be connected to a rotatable part 2 of a ceiling fan, that is in the form of a coupler disc, and that is formed with a plurality of angularly spaced-apart holes 111. A plurality of second parts 12 (only one is visible in FIGS. 1 and 2) are respectively connected to the first part 11 through a plurality of fastener units 13. Each of the second parts 12 has an outer end 123 adapted to be connected to a fan blade 3, and an inner end 121 that is opposite to the outer end 123 and that is formed with a pair of recesses 124, each of which has a bottom formed with a threaded hole 125. Each of the fastener units 13 includes an elastic seat 131 that is disposed in a respective one of the recesses 124, and a screw 132 that extends through a respective one of the holes 111 in the first part 11 and the respective seat 131 and into the respective threaded hole 125 in the inner end 121 of the second part 12 so as to interconnect the first and second parts 11, 12. The aforesaid conventional coupling device 1 is disadvantageous in that coupling of the first and second parts 11,12 is time-consuming and inconvenient to conduct. Moreover, the screws 132 of the fastener units 13 tend to loosen after a period of use.

### SUMMARY OF THE INVENTION

Therefore, the object of this invention is to provide a coupling device that can be used to interconnect a fan blade to a rotatable part of a ceiling fan and that is capable of overcoming the aforesaid disadvantages of the conventional coupling device.

Accordingly, the coupling device of the present invention is used to connect a fan blade to a rotatable part of a ceiling fan, and includes: a first part; a second part; an insert-holding seat that is formed on the first part, that defines a receiving hole extending in a longitudinal direction, and that has a rear end face confining a rear end of the receiving hole and formed with an engaging groove which is in spatial communication with the receiving hole; a limiting member mounted rotatably on the first part, disposed rearwardly of the insert-holding seat, having a front end face that confronts the rear end face of the insert-holding seat and that is formed with a tongue-arresting groove, and rotatable relative to the insert-holding seat between a first angular position, in which, the tongue-arresting groove in the limiting member is angularly offset from the engaging groove in the insert-holding seat, and a second angular position, in which, the tongue-arresting groove in the limiting member is registered with the engaging groove in the insert-holding seat; and an insert formed on the second part and having an engaging tongue, the insert being insertable into the insert-holding seat in such a manner that the engaging tongue extends through the receiving hole and into the tongue-arresting groove when the limiting member is disposed at the first angular position so as to permit co-rotation of the insert with the limiting member between the first and second angular positions, the engaging tongue being extendible into the engaging groove in the insert-holding seat and being disengageable from the tongue-arresting groove when the insert co-rotates with the limiting member to the second angular position, the engaging tongue being restrained by the limiting member from moving out of the engaging groove in the longitudinal direction when the engaging tongue is disengaged from the tongue-arresting groove and the limiting member is moved from the second angular position to the first angular position.

### BRIEF DESCRIPTION OF THE DRAWINGS

These and other features and advantages of this invention will become apparent in the following detailed description of the preferred embodiment of this invention, with reference to the accompanying drawings, of which:

FIG. 1 is an exploded perspective view of a conventional coupling device for connecting a fan blade to a rotatable part of a ceiling fan;

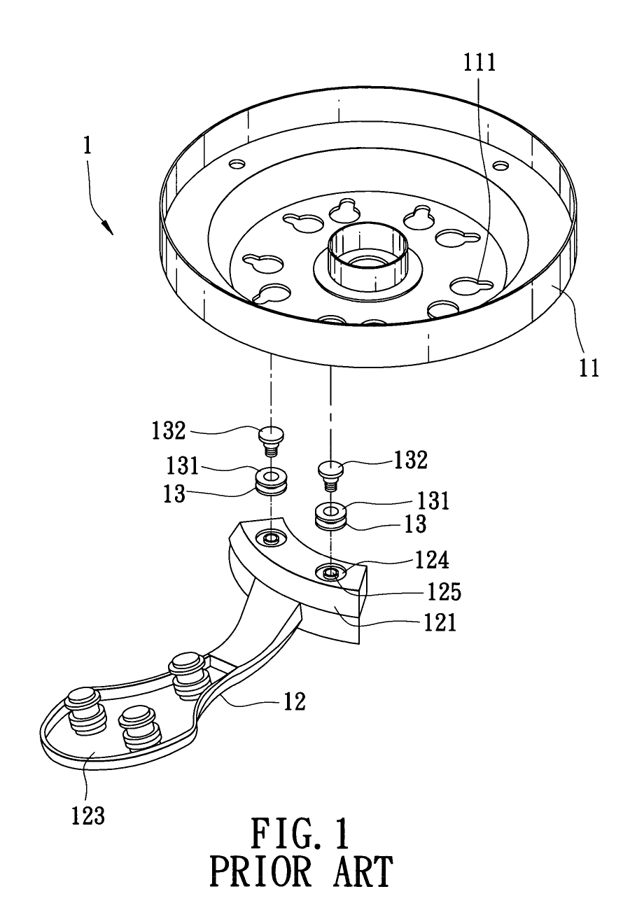

FIG. 2 illustrates how the conventional coupling device connects the fan blade to the rotatable part of the ceiling fan;

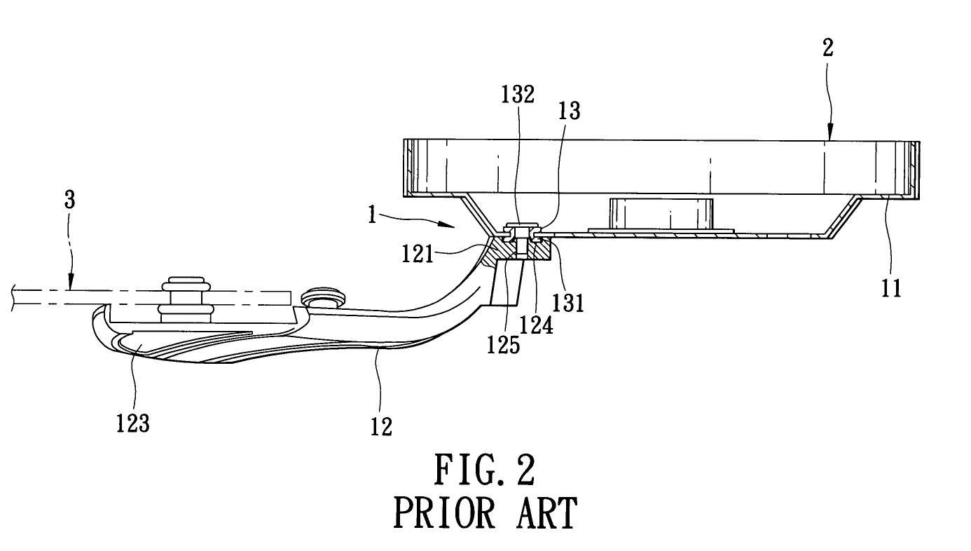

FIG. 3 is an exploded perspective view of the preferred embodiment of a coupling device according to the present invention for connecting a fan blade to a rotatable part of a ceiling fan;

FIG. 4 illustrates how first and second parts of the preferred embodiment connect the fan blade to the rotatable part of the fan blade;

FIG. 5 is an exploded schematic side view, illustrating how the first part is removed from the second part; and

FIG. 6 is a schematic side view of the preferred embodiment, illustrating a state, in which the first and second parts can be conveniently detached from each other.

### DETAILED DESCRIPTION OF THE PREFERRED EMBODIMENT

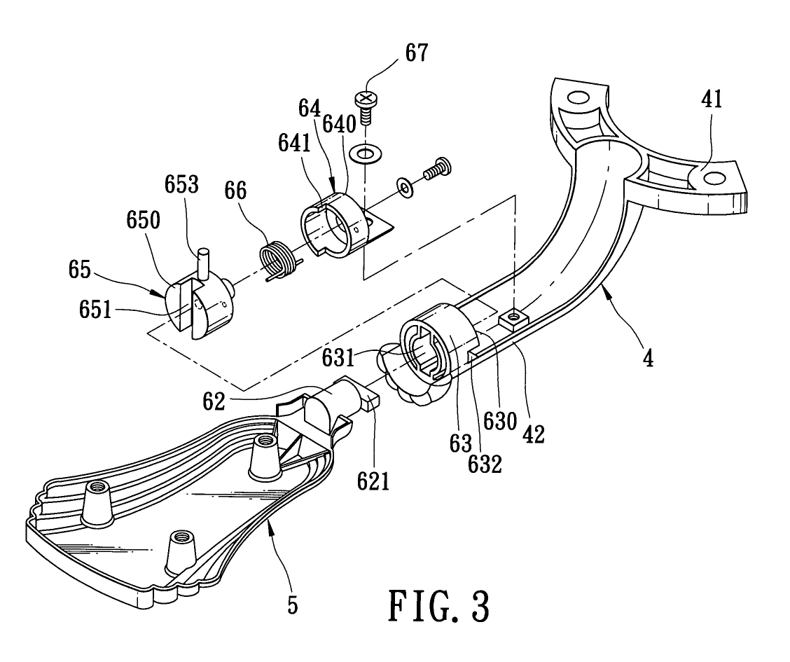

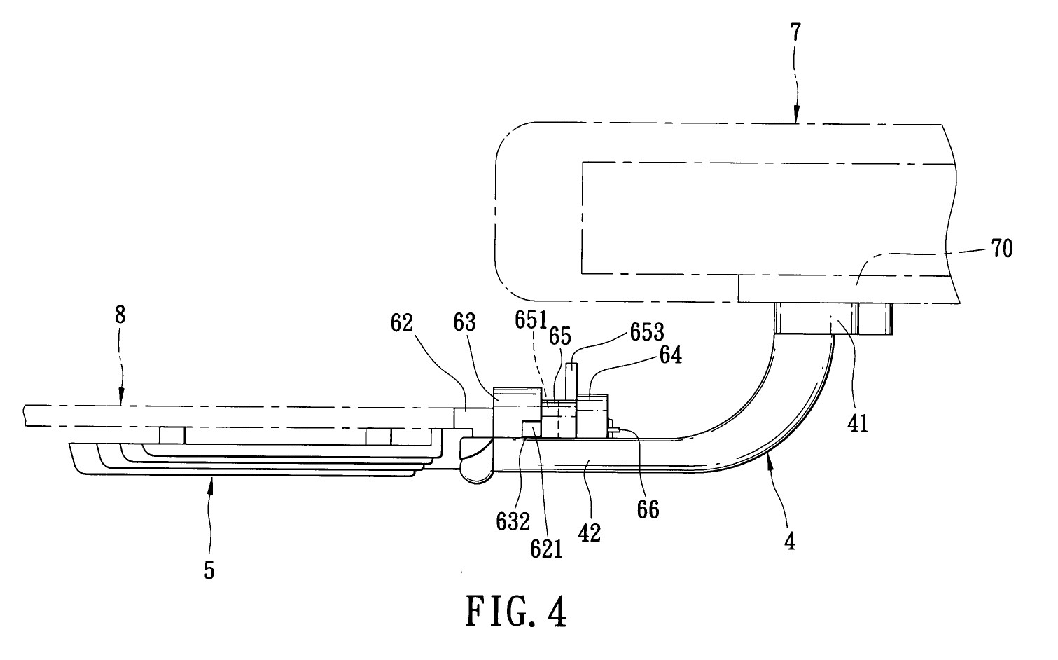

Referring to FIGS. 3 and 4, the preferred embodiment of a coupling device according to the present invention is used to connect a fan blade 8 to a rotatable part 70, such as a rotor, of a ceiling fan 7 (see FIG. 4), and includes a first part 4, a second part 5, an insert-holding seat 63, a limiting member 65, an insert 62, a spring-mounting seat 64, and an urging member 66.

As illustrated, the first part 4 includes an inner end 41 adapted to be fastened to the rotatable part 70 of the ceiling fan 7, and an outer end 42 opposite to the inner end 41.

The second part 5 is in the form of a leaf and is adapted to be connected to the fan blade 8.

The insert-holding seat 63 is formed on the outer end 42 of the first part 4, defines a receiving hole 631 extending in a longitudinal direction, and has a rear end face 630 confining a rear end of the receiving hole 631. The rear end face 630 of the insert-holding seat 63 is formed with an engaging groove 632 which is in spatial communication with the receiving hole 631.

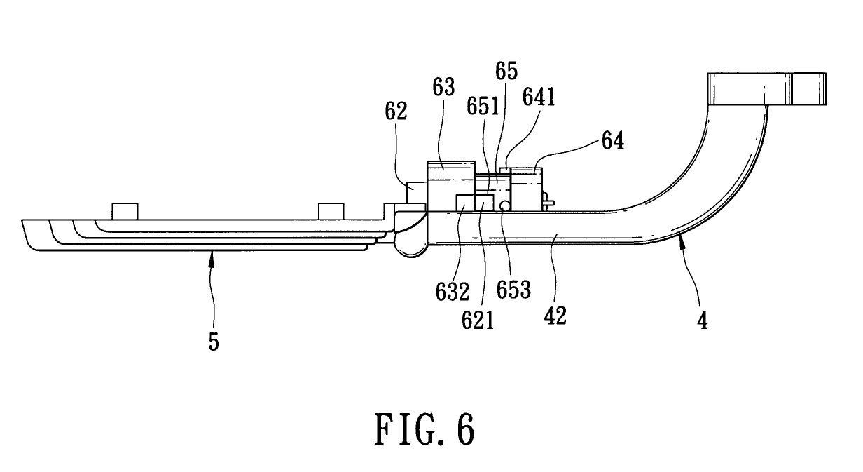

The limiting member 65 is mounted rotatably on the outer end 42 of the first part 4, is disposed rearwardly of the insert-holding seat 63, and has a front end face 650 that confronts the rear end face 630 of the insert-holding seat 63 and that is formed with a tongue-arresting groove 651. The limiting member 65 is rotatable relative to the insert-holding seat 63 between a first angular position (see FIG. 4), in which, the tongue-arresting groove 651 in the limiting member 65 is angularly offset from the engaging groove 632 in the insert-holding seat 63, and a second angular position, in which, the tongue-arresting groove 651 in the limiting member 65 is registered with the engaging groove 632 in the insert-holding seat 63 (see FIG. 6).

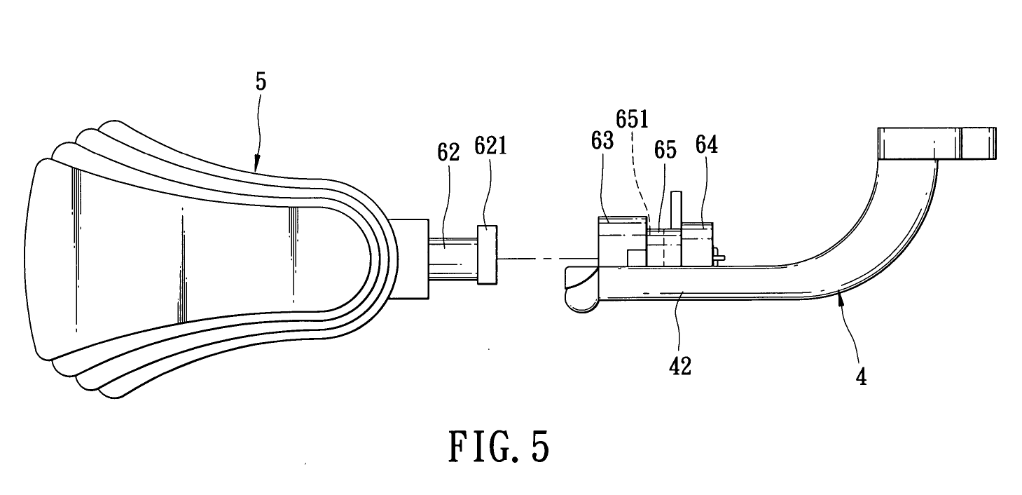

The insert 62 is in the form of a cylindrical rod, is formed on the second part 5, and has an engaging tongue 621 that is disposed rearwardly of the rear end face 630 of the insert-holding seat 63 when the insert 62 is inserted through the receiving hole 631 in the insert-holding seat 63. Particularly, the insert 62 is insertable into the insert-holding seat 63 in such a manner that the engaging tongue 621 extends through the receiving hole 631 and into the tongue-arresting groove 651 in the limiting member 65 when the limiting member 65 is disposed at the first angular position (see FIG. 5) so as to permit co-rotation of the insert 62 with the limiting member 65 between the first and second angular positions. When the insert 62 co-rotates with the limiting member 65 to the second angular position, the engaging tongue 621 of the insert 62 is extendible into the engaging groove 632 in the insert-holding seat 63 and is disengageable from the tongue-arresting groove 651 (see FIG. 6). Under this condition, when the engaging tongue 621 is disengaged from the tongue-arresting groove 651, and the limiting member 65 is moved from the second angular position to the first angular position, the engaging tongue 621 is restrained by the limiting member 65 from moving out of the engaging groove 632 in the insert-holding seat 63 in the longitudinal direction, as shown in FIG. 4. When the limiting member 65 is disposed at the second angular position, as best shown in FIG. 6, the engaging tongue 621 of the insert 62 is movable in the longitudinal direction, and is capable of moving out of the engaging groove 632 in the insert-holding seat 63 and into the tongue-arresting groove 651 in the limiting member 65 so as to co-rotate with the limiting member 65 from the second angular position of FIG. 6 to the first angular position, thereby permitting removal of the insert 62 from the insert-holding seat 63, as best shown in FIG. 5.

The limiting member 65 includes an operating lever 653 projecting outwardly therefrom. A spring-mounting seat 64 is mounted securely on the first part 4 through a screw 67, and is disposed rearwardly of the limiting member 65.

The urging member 66 is mounted on the spring-mounting seat 64 for constantly urging the limiting member 65 to move from the second angular position to the first angular position.

In this embodiment, the limiting member 65 has a cylindrical cross section. The spring-mounting seat 64 includes a cylindrical casing 640 that receives partially the limiting member 65 therein, and that is formed with a curved segment 641 projecting axially therefrom. The curved segment 641 of the spring-mounting seat 64 abuts against the operating lever 653 to stop further angular movement of the limiting member 65 when the limiting member 65 is restored from the second angular position to the first angular position by the urging action of the urging member 66.

Since coupling and detaching of the first and second parts 4,5 of the coupling device of the present invention is easy and convenient to conduct, the aforesaid disadvantages of the prior art are accordingly solved.

With this invention thus explained, it is apparent that numerous modifications and variations can be made without departing from the scope and spirit of this invention. It is therefore intended that this invention be limited only as indicated by the appended claims.

1. A coupling device for connecting a fan blade to a rotatable part of a ceiling fan, said coupling device comprising:
a first part adapted to be connected to one of the fan blade and the rotatable part;
a second part adapted to be connected to the other one of the fan blade and the rotatable part;
an insert-holding seat that is formed on said first part, that defines a receiving hole extending in a longitudinal direction, and that has a rear end face confining a rear end of said receiving hole and formed with an engaging groove which is in spatial communication with said receiving hole;
a limiting member mounted rotatably on said first part, disposed rearwardly of said insert-holding seat, having a front end face that confronts said rear end face of said insert-holding seat and that is formed with a tongue-arresting groove, and rotatable relative to said insert-holding seat between a first angular position, in which, said tongue-arresting groove in said limiting member is angularly offset from said engaging groove in said insert-holding seat, and a second angular position, in which, said tongue-arresting groove in said limiting member is registered with said engaging groove in said insert-holding seat; and
an insert formed on said second part and having an engaging tongue, said insert being insertable into said insert-holding seat in such a manner that said engaging tongue extends through said receiving hole and into said tongue-arresting groove when said limiting member is disposed at said first angular position so as to permit co-rotation of said insert with said limiting member between said first and second angular positions, said engaging tongue being extendible into said engaging groove in said insert-holding seat and being disengageable from said tongue-arresting groove when said insert co-rotates with said limiting member to said second angular position, said engaging tongue being restrained by said limiting member from moving out of said engaging groove in said longitudinal direction when said engaging tongue is disengaged from said tongue-arresting groove and said limiting member is moved from said second angular position to said first angular position.

2. The coupling device as defined in claim 1, wherein said limiting member includes an operating lever projecting outwardly therefrom, said coupling device further comprising a spring-mounting seat mounted securely on said first part, disposed rearwardly of said limiting member, and including a cylindrical casing that receives said limiting member therein and a curved segment that projects axially from said cylindrical casing, said curved segment of said spring-mounting seat abutting against said operating lever to stop further angular movement of said limiting member when said limiting member is restored from said second angular position to said first angular position.

3. The coupling device as defined in claim 2, further comprising an urging member mounted on said spring-mounting seat for urging constantly said limiting member to move from said second angular position to said first angular position.
